(19) United States
(12) Patent Application Publication
(10) Pub. No.: US 2026/0042100 A1
(43) Pub. Date: Feb. 12, 2026

(54) MAGNETIC SEPARATOR WITH WAVE DEFLECTOR

(71) Applicant: Magnetic Products, Inc., Highland, MI (US)

(72) Inventors: Robert Lutes, Whitmore Lake, MI (US); Robert Timmer, Hartland, MI (US)

(21) Appl. No.: 19/291,808

(22) Filed: Aug. 6, 2025

Related U.S. Application Data
(60) Provisional application No. 63/680,259, filed on Aug. 7, 2024.

(51) Int. Cl. B03C 1/14; B65G 53/04; B65G 53/52

(52) U.S. Cl. CPC B03C 1/14; B65G 53/04; B65G 53/52; B03C 2201/20; B03C 2201/28; B65G 2812/1608

(57) ABSTRACT

A magnetic separator for a pneumatic conveyor system may include a duct, at least one face plate assembly, at least one magnet assembly, and a wave-shaped deflector. The duct may define a passage through which an airflow and a powder material suspended in the airflow is flowable. The powder material may include non-ferrous material and ferrous material. The face plate assembly and the magnet assembly may be disposed on a side of the duct. The magnet assembly may provide at least one magnetic field that draws the ferrous material toward the face plate assembly and retains the ferrous material on the face plate assembly. The wave-shaped deflector may be arranged in the passage. The wave-shaped deflector may be structured and arranged to direct and/or guide the airflow and the powder material suspended therein through the passage and, at least in some sections, toward the face plate assembly.

### CROSS-REFERENCE TO RELATED APPLICATIONS

This application claims priority to U.S. Provisional Ser. No. 63/680,259 , filed on Aug. 7, 2024, the content of which is hereby incorporated by reference in its entirety.

### TECHNICAL FIELD

This disclosure relates generally to magnetic separators, and in particular, to magnetic separators for pneumatic conveying systems, such as those used to move products and/or materials (e.g., powder products and/or materials) from one location to another.

### BACKGROUND

Pneumatic conveying systems are commonly used to move products and/or materials (e.g., powder materials) from one location to another. The powder material is mixed with a high-speed airflow, such that the powder material is mixed and stays suspended in the airflow, and is blown down pipework to reach a final destination. The powder material that is suspended in the airflow may be referred to as being in a dilute phase and/or as the dilute phase powder material. In some instances, the powder material includes and/or contains desired non-ferrous material and undesired ferrous material. As such, while the airflow with the suspended powder material is traveling to the final destination, one or more magnetic separators may be used to remove the undesired ferrous material from the dilute phase powder material.

The magnetic separator generates one or more magnetic fields, which attract the ferrous material but do not attract the non-magnetic powder material, to draw and/or remove the ferrous material out of the dilute phase powder material and/or the airflow as the airflow passes through the magnetic separator. Various particles of the ferrous material may have different removal conditions and/or parameters that must be met for successful removal from the airflow. For example, some particles of the ferrous material may require a strong magnetic force (e.g., a high magnetic flux density) to be removed from the airflow, while a weaker magnetic force (e.g., a low magnetic flux density) may be sufficient to remove other particles of the ferrous material from the airflow. As another example, some particles of the ferrous material may only need to spend a short amount of time within the magnetic field(s) of the magnetic separator to be removed from the airflow, while other particles of the ferrous material may need to spend a longer duration of time within the magnetic field(s) of the magnetic separator to be removed from the airflow.

Conventional magnetic separators are typically able to satisfy the removal conditions and/or parameters for some, but not all, of the particles of ferrous material contained in the powder material. As a result, conventional magnetic separators are typically able to remove some particles of ferrous material from the dilute phase powder material, but are unable to remove other particles of ferrous material. Those conventional magnetic separators that are capable of satisfying the removal conditions and/or parameters for a larger portion of the particles of ferrous material contained in the powder material and therefore capable of removing a greater portion of the ferrous material from the powder material (i.e., those with better magnetic capture performance) typically do so inefficiently and/or are extremely costly.

Therefore, a need exists for an improved magnetic separator.

### SUMMARY

The disclosure is directed to a magnetic separator for a pneumatic conveying system.

According to the disclosure, a magnetic separator for a pneumatic conveyor system may include a duct, at least one face plate assembly, at least one magnet assembly, and a wave-shaped deflector. The duct may define a passage through which a fluid flow (e.g., airflow) carrying a suspension (e.g., a powder material) is flowable. The powder material may include non-ferrous material and ferrous material. The face plate assembly and the magnet assembly may be disposed on a side of the duct. The magnet assembly may provide at least one magnetic field that draws the ferrous material toward the face plate assembly and retains the ferrous material on the face plate assembly. The wave-shaped deflector may be arranged in the passage. The wave-shaped deflector may be structured and arranged to direct and/or guide the fluid flow and suspension (e.g., an airflow and a powder material suspended therein) through the passage and, at least in some sections, toward the face plate assembly. The magnetic separator achieves advantages with respect to improved backpressure or pressure drop, quick service (maintenance) time, high efficiency, and high gauss for filtering ferrous material from the fluid flow passing through the duct.

According to the disclosure, a magnetic separator for a pneumatic conveyor system may include a duct, a plurality of adjustable face plate assemblies, a plurality of adjustable magnet assemblies, and a wave-shaped deflector. The duct may define a passage through which a fluid flow (e.g., an airflow) carrying a suspension (e.g., a powder material) is flowable. The powder material may include non-ferrous material and ferrous material. The plurality of adjustable face plate assemblies may include a first face plate assembly disposed on a first side of the duct and a second face plate assembly disposed on a second side of the duct. The plurality of adjustable magnet assemblies may include a first magnet assembly disposed on the first side of the duct and a second magnet assembly disposed on the second side of the duct. The plurality of magnet assemblies may provide a plurality of magnetic fields that draw the ferrous material toward the plurality of face plate assemblies and retain the ferrous material on the plurality of face plate assemblies. The deflector may be arranged in the passage. The deflector may be structured and arranged to direct the fluid flow and suspension (e.g., an airflow and a powder material suspended therein) through the passage and, at least in some regions, toward at least one of the plurality of face plate assemblies.

Various other features and advantages will be made apparent from the following detailed description and the drawings. For example, it will be apparent by the disclosure that the system and method disclosed could be used in various other contexts including with different sizes of conveyor systems and with a variety of different conveyed materials.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view of an exemplary magnetic separator in a cleaning state;

FIG. 2 is a cross-sectional, perspective view of the duct and the wave deflector of the magnetic separator of FIG. 1;

FIG. 3A is a cross-sectional, top-down view of the magnetic separator of FIG. 1 in an operation state showing separation and/or removal of ferrous material from dilute phase powder material moving through the magnetic separator;

FIG. 3B is a cross-sectional, top-down view of the magnetic separator of FIG. 1 in an operation state showing the wave deflector guiding the airflow through the various regions of the passage of the magnetic separator; and

FIG. 4 is an image of an air speed and flow simulation through the passage of another exemplary magnetic separator.

### DETAILED DESCRIPTION

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

This disclosure relates generally to a magnetic separator 12 for a pneumatic conveying system 10. The magnetic separator 12 is configured to remove undesired ferrous material 34 from a source material 30 (e.g., a powder material), which also includes and/or contains desired non-ferrous material 32, that is suspended in an airflow 20. The powder material 30 that is suspended in the airflow 20 may be referred to as being in a dilute phase and/or as the dilute phase powder material 30. The magnetic separator 12 is configured to generate one or more magnetic fields, which attract the ferrous material 34 but do not attract the non-magnetic and/or non-ferrous material 32, to separate, draw out, and/or remove the ferrous material 34 from the dilute phase powder material 30 and/or the airflow 20 as the airflow 20 passes through the magnetic separator 12. The magnetic separator 12 is adjustable to an operation state for removing and/or collecting ferrous material 34 from the airflow 20 and/or the dilute phase powder material 30 and to a cleaning state for discharging, clearing, and/or removal of the collected ferrous material 36 that has been separated and/or removed from the airflow 20 and/or the dilute phase powder material 30.

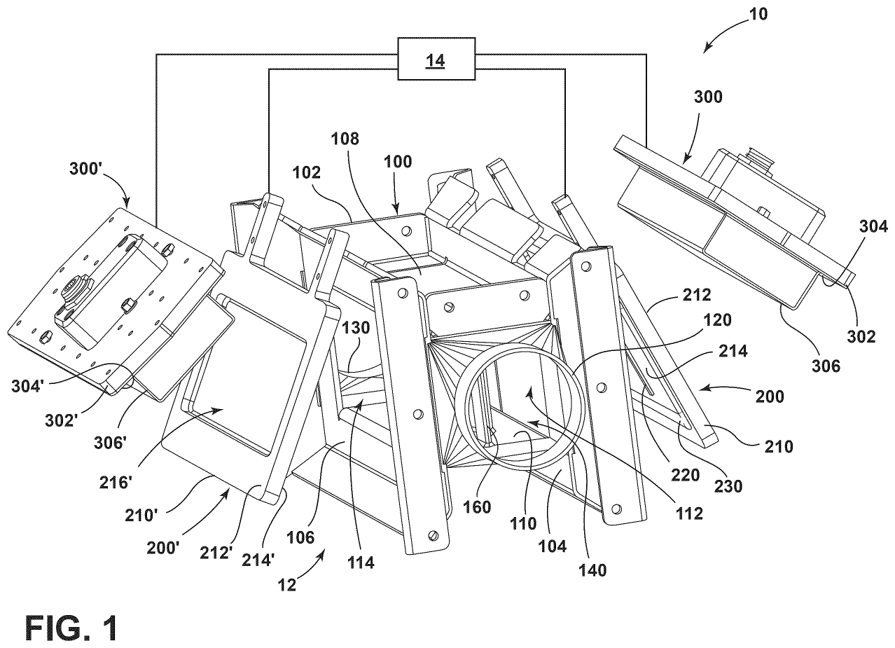

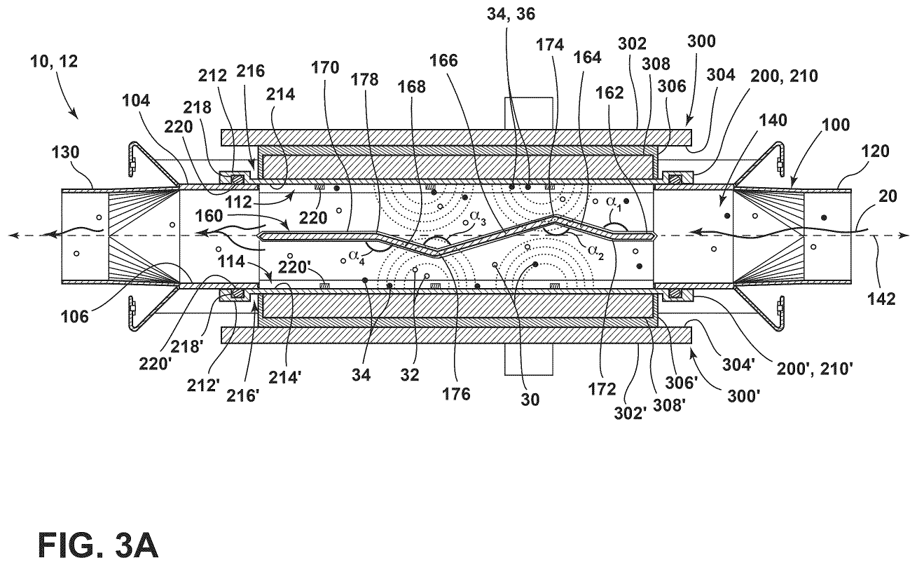

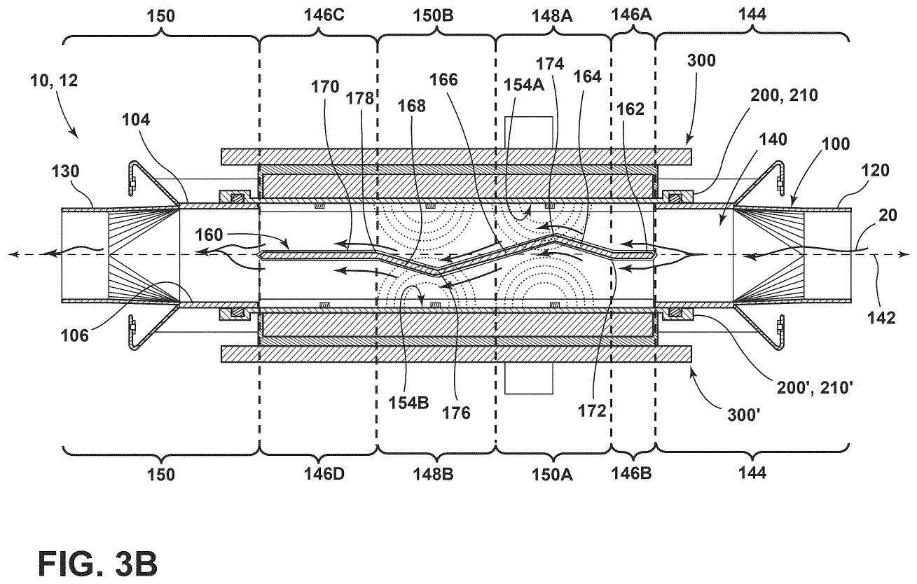

The magnetic separator 12 includes a duct 100 that at least partially defines a passage 140, at least one wave-shaped deflector 160 arranged in the passage 140, a plurality of adjustable face plate assemblies 200, 200′, a plurality of adjustable magnet assemblies 300, 300′, and one or more actuators 14 (e.g., a motor, an electric motor, a pneumatic actuator, a hydraulic actuator, etc.) for adjusting the face plate assemblies 200, 200′ and/or the magnet assemblies 300, 300′. A first face plate assembly 200 and a first magnet assembly 300 are disposed on a first side of the duct 100, while a second face plate assembly 200′ and a second magnet assembly 300′ are disposed on an opposite, second side of the duct 100. The first face plate assembly 200 and the first magnet assembly 300 may be tied and/or coupled to the second face plate assembly 200′ and the second magnet assembly 300′ magnetically and/or mechanically. The face plate assemblies 200, 200′ and the magnet assemblies 300, 300′ are operatively connected to the actuator 14 and are moveable and/or adjustable by the actuator 14, such as via one or more linkages, hinges, pins, rotatable arms, tracks, rails, and/or other suitable types of mechanical sub-assemblies. The magnetic separator 12 is adjustable to an operation state (see, e.g., FIGS. 3A, 3B) and a cleaning state (see, e.g., FIG. 1) via the actuator 14. The face plate assemblies 200, 200′ are each moveable and/or adjustable relative to the duct 100 (e.g., to a closed position, one or more open positions, and a cleaning position) via the actuator 14. The magnet assemblies 300, 300′ are each moveable and/or adjustable relative to the duct 100 and relative to the face plate assemblies 200, 200′ (e.g., to an engaged position and an unengaged position) via the actuator 14. It will be appreciated that the actuator 14 may be coupled to a controller (e.g., a circuit board), which controls the actuator 14 to move/adjust the face plate assemblies 200, 200′ and/or magnet assemblies 300, 300′. Although the face plate assemblies 200, 200′ and magnet assemblies 300, 300′ are described as movable/adjustable relative to one another, as discussed below, it will be appreciated that the magnet assemblies 300, 300′ may be coupled for rotation/movement with an associated face plate assembly 200, 200′ without departing from the scope of the disclosure.

When the magnetic separator 12 is in the operation state (see, e.g., FIGS. 3A, 3B), the face plate assemblies 200, 200′ are each in their respective closed positions, the magnet assemblies 300, 300′ are each in their respective engaged positions, and an airflow 20 and dilute phase powder material 30 (i.e., powder material 30 suspended in the airflow 20) flow through the passage 140 of the duct 100. Ferrous material 34 of the dilute phase powder material 30 is drawn and/or attracted toward and/or to the face plate assemblies 200, 200′ (e.g., via magnetic fields provided by the magnet assemblies 300, 300′) as the airflow 20 and dilute phase powder material 30 flows through the passage 140. The ferrous material 34 eventually contacts the face plate assemblies 200, 200′ and is held and/or maintained on the face plate assemblies 200, 200′ by the magnetic fields provided by the magnet assembly 300 (i.e., via magnetic forces), which causes the ferrous material 34 to collect and/or accumulate on the face plate assemblies 200, 200′. Ferrous material 34 that has collected on and/or is being retained on the face plate assemblies may be referred to as collected ferrous material 36. The collected ferrous material 36 is thereby prevented from continuing to flow through the passage 140 and passing out of the duct 100 (e.g., via the outlet 130) with the airflow 20 and the remainder of the dilute phase powder material 30 (e.g., the non-ferrous material 32). In this way, ferrous material 34 of the dilute phase powder material 30 is separated and/or removed from the airflow 20 and the dilute phase powder material 30 by the magnetic separator 12 such that the airflow 20 and/or the dilute phase powder material 30 exiting and/or output by the magnetic separator 12 is substantially free of ferrous materials 34 (e.g., only includes non-ferrous material 32).

When the magnetic separator 12 is in the cleaning state (see, e.g., FIG. 1), the face plate assemblies 200, 200′ are each in their respective cleaning positions and the magnet assemblies 300, 300′ are each in their respective unengaged positions. The ferrous material 34 that has been separated and/or removed from the airflow 20 and/or the dilute phase powder material 30 and that has collected and/or accumulated on the face plate assemblies 200, 200′ (i.e., the collected ferrous material 36) can be released, detached, removed and/or cleared from the face plate assemblies 200, 200′ without the collected ferrous material 36 re-entering the duct 100, the passage 140, and/or the airflow 20 when in the cleaning state. The collected ferrous material 36 may be removed and/or cleared from the face plate assemblies 200, 200′, for example, via gravity, a flow of liquid and/or gaseous fluid, physical contact (e.g., scraped, wiped, etc.), and/or in other suitable manners. Removal and/or clearing of the collected ferrous material 36 from the face plate assemblies 200, 200′ includes and/or involves reducing the magnetic forces and/or the strength of the magnetic fields that hold and/or maintain the collected ferrous material 36 to and/or on the face plate assemblies 200, 200′, such as by increasing the respective distance between the magnet assembly 300, 300′ and the associated face plate assembly 200, 200′ and/or the collection plate 210, 210′ thereof (e.g., via moving and/or adjusting the magnet assemblies 300, 300′ from the engaged position to the unengaged position). The reduced magnetic forces and/or strength of the magnetic fields allows for the collected ferrous material 36 to be separated, removed, and/or cleared from the collection plate 210 with greater ease and/or with less difficulty and/or force. In some examples, the magnetic forces and/or the strength of the magnetic fields are sufficiently reduced to allow for the collected ferrous material 36 to naturally fall from and/or off of the face plate assemblies 200, 200′ due to gravity.

The magnetic separator 12 may adjust from the operation state to the cleaning state to remove, expel, discharge, and/or clear the collected ferrous material 36 once one or more of the face plate assemblies 200, 200′ become saturated with ferrous material 34, an amount of collected ferrous material 36 on one or more of the face plate assemblies 200, 200′ reaches a collection and/or accumulation threshold, a removal/collection efficiency of the magnetic separator 12 falls below a predetermined efficiency threshold, and/or a removal/collection rate of the magnetic separator 12 falls below a predetermined rate threshold. Operation of the pneumatic conveying system 10, the airflow 20 through the duct 100, and/or the introduction of the powder material 30 into the airflow 20 may be stopped prior to the magnetic separator 12 adjusting from the operation state to the cleaning state to prevent the powder material 30 from escaping into the external environment through openings 112, 114 of duct 100 (i.e., to avoid and/or reduce loss of the powder material 30). After the collected ferrous material 36 has been cleared from the face plate assemblies 200, 200′, the magnetic separator 12 may adjust from the cleaning state to the operation state and the airflow 20 through the duct 100, the introduction of the powder material 30 into the airflow 20, and/or operation of the pneumatic conveying system 10 may resume.

Adjustment from the operation state to the cleaning state includes adjusting the first face plate assembly 200 from the closed position to the cleaning position while simultaneously adjusting the second face plate assembly 200′ from the closed position to the cleaning position. It also includes subsequently adjusting the first magnet assembly 300 from the engaged position to the unengaged position while simultaneously adjusting the second magnet assembly 300′ from the engaged position to the unengaged position. Simultaneous adjustment is not required, however. Adjusting the magnet assemblies 300, 300′ from the engaged position to the unengaged position increases the respective distance between the magnet assembly 300, 300′ and the associated face plate assembly 200, 200′ and/or the collection plate 210, 210′ thereof, which in turn reduces the magnetic forces and/or the strength of the magnetic fields that hold and/or maintain the collected ferrous material 36 to and/or on the face plate assemblies 200, 200′.

Adjustment from the cleaning state to the operation state includes adjusting the first magnet assembly 300 from the unengaged position to the engaged position while simultaneously adjusting the second magnet assembly 300′ from the unengaged position to the engaged position. It also includes (e.g., subsequently) adjusting the first face plate assembly 200 from the cleaning position to the closed position while simultaneously adjusting the second face plate assembly 200′ from the cleaning position to the closed position. Simultaneous adjustment is not required, however.

Conceivably, the face plate assemblies 200, 200′ may be adjusted to the cleaning position and/or to the closed position sequentially and/or the magnet assemblies 300, 300′ may be adjusted to the engaged position and/or unengaged position sequentially. Alternatively, one of the face plate assemblies 200, 200′ may be adjusted to the cleaning position, the associated magnet assembly 300, 300′ adjusted to the unengaged position then back to the engaged position, the face plate assembly 200, 200′ returned to the closed position, and then this process subsequently repeated with the other face plate assembly 200, 200′ and the other magnet assembly 300, 300′.

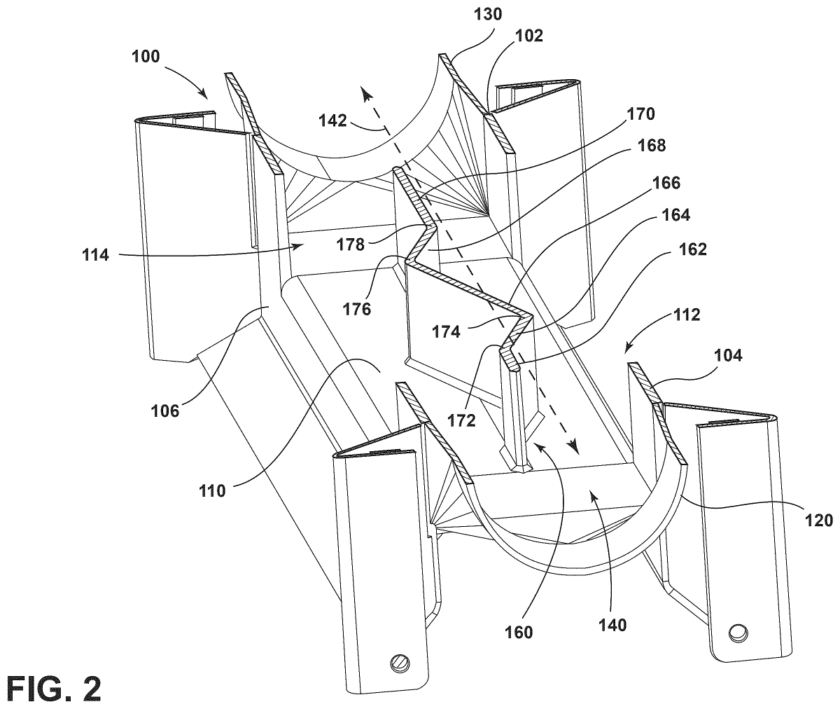

As generally illustrated in FIGS. 1-3B, the duct 100 includes a frame 102, an inlet 120, and an outlet 130. The duct 100 and/or the frame 102 includes and/or is defined by a plurality of walls (e.g., a first wall 104, a second wall 106, a third/top wall 108, a fourth/bottom wall 110) that at least partially define and/or delimit a passage 140 through which the airflow 20 and/or the dilute phase powder material 30 flow during operation. The inlet 120 and outlet 130 are disposed at opposite longitudinal and/or axial ends of the passage 140. The airflow 20 and/or dilute phase powder material 30 enters the magnetic separator 12 and/or the passage 140 of the duct 100 via the inlet 120. The airflow 20 and/or dilute phase powder material 30 exits and/or is discharged from the magnetic separator 12 and/or the passage 140 of the duct 100 via the outlet 130. A first wall 104 (e.g., a first sidewall) and an opposite, second wall 106 (e.g., second sidewall) of the duct 100 at least partially define the passage 140. A third and/or top wall 108 and an opposite fourth and/or bottom wall 110 of the duct 100 extend between and connect the first wall 104 and the second wall 106 and also at least partially defined the passage 140. The first wall 104 and the second wall 106 include a first opening 112 and a second opening 114, respectively, that fluidically connect the passage 140 to the external environment. The openings 112, 114 are disposed in, defined by, and extend completely through the respective wall 104, 106 in a direction transverse (e.g., perpendicular) to the longitudinal direction of the passage 140 and to the wave deflector 160. Although the duct 100 and passage 140 are shown to have a profile and/or cross-section that is a rectangular shape defined by four generally planar walls 104-110, it will be appreciated that the duct 100 and passage 140 may have a profile and/or cross-section of other shapes (e.g., circular, elliptical, triangular, hexagonal, etc.) defined by any number of walls with a variety of configurations (e.g., a singular annular wall, one or more planar walls, one or more curved walls, etc.) without departing from the scope of the disclosure.

The magnetic separator 12 and/or the duct 100 further includes at least one wave-shaped deflector 160, which may also be referred to as a wave deflector 160. The wave deflector 160 is disposed in the passage 140 and directs, guides, and/or deflects the airflow 20 and the dilute phase powder material 30 through the passage 140 and toward/away from the face plate assemblies 200, 200′. The wave deflector 160 enables the magnetic separator 12 to remove more ferrous material 34 and/or a greater variety of ferrous material 34 particles from the dilute phase powder material 30 and, therefore, improves the magnetic capture performance of the magnetic separator 12. The wave deflector 160 has a low approach angle, which not only reduces the amount of damage sustained by the desired non-ferrous material 32 in the dilute phase powder material 30, but also reduces the amount of abrasion experienced by the wave deflector 160 (e.g., due to impact, contact, sliding, and/or other interaction with the particles of the dilute phase powder material 30). The wave deflector 160 also has relatively low air resistance, reducing the pressure drop and/or backpressure in the magnetic separator 12.

The wave deflector 160 is structured as a continuous, monolithic wall including and/or formed by a plurality of wall sections 162-170 that are angled relative to one another. The wave deflector 160 (e.g., the wall sections 162-170) is disposed on and/or connected to the third/top wall 108 and the fourth/bottom wall 110 of the duct 100, and is offset and/or disposed space apart from the inlet 120 and the outlet 130 (e.g., in the flow direction). The wave deflector 160 and/or each of the wall sections 162-170 extends completely across the passage 140 from the third/top wall 108 to the fourth/bottom wall 110 of the duct 100, generally in a direction transverse (e.g., oblique or perpendicular) to the third and fourth walls 108, 110. While the illustrative example herein includes a single wave deflector 160, other exemplary magnetic separators 12 and/or ducts 100 include a plurality of wave deflectors 160, which may be disposed one after another in the direction of the airflow 20 and/or a longitudinal direction of the passage 140 for example. Additionally, the wave deflector 160 may not be a continuous, monolithic wall and the wall sections 162-170 may be structured as separate, individual walls that are disposed spaced apart from one another, that abut one another, and/or that are connected to one another (e.g., via connectors, fasteners, brackets, etc.). In other examples, the wave deflector 160 may not be connected to one of the third and fourth walls 108, 110 and/or may only extend partially across the passage 140.

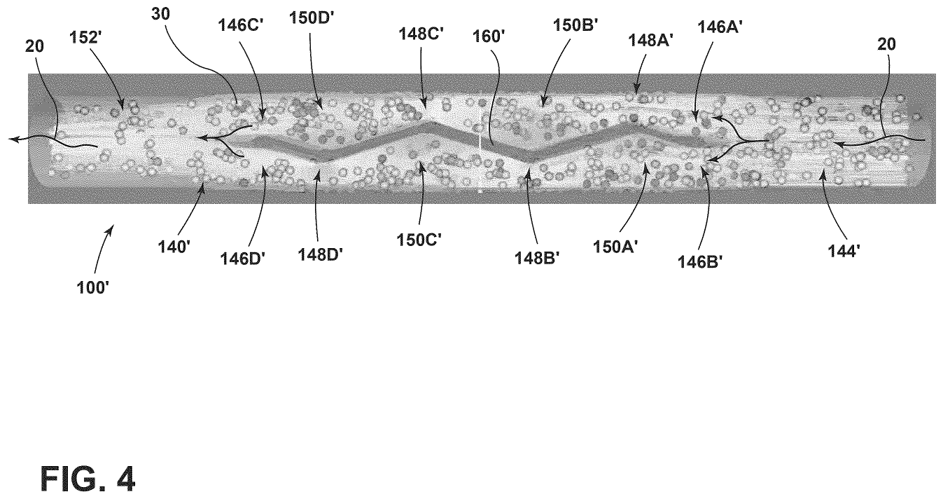

The plurality of wall sections 162-170 include a first wall section 162, a second wall section 164, a third wall section 166, a fourth wall section 168, and a fifth wall section 170. The first wall section 162 is disposed closest to the inlet 120, arranged centrally in the passage 140 (e.g., equidistant from the first and second walls 104, 106), and extends substantially parallel to the longitudinal direction and/or a centerline 142 of the passage 140 and/or the duct 100. The second wall section 164 meets the first wall section 162 at a first joint 172 and projects transversely (e.g., obliquely) from the first wall section 162 in a direction toward the first face plate assembly 200. The third wall section 166 meets the second wall section 164 at a second joint 174 and projects transversely (e.g., obliquely) from the second wall section 164 in a direction toward the second face plate assembly 200′. The fourth wall section 168 meets the third wall section 166 at a third joint 176 and projects transversely (e.g., obliquely) from the third wall section 166 in a direction toward the first face plate assembly 200. The fifth wall section 170 meets the fourth wall section 168 at a fourth joint 178, projects transversely (e.g., obliquely) from the fourth wall section 168 in a direction toward the outlet 130, is disposed closest to the outlet 130, is arranged centrally in the passage 140 (e.g., equidistant from the first and second walls 104, 106), and extends substantially parallel to the longitudinal direction and/or the centerline 142 of the passage 140 and/or the duct 100. Five wall sections 162-170 is not required, however, and the wave deflector 160 may include any number of wall sections (e.g., seven wall sections as depicted in the flow simulation of FIG. 4). Additionally, the wall sections 162-170 each generally planar, extend linearly, and form relatively sharp angles at the joints 172-178 in the illustrative examples herein, although it will be appreciated that one or more of the wall sections 162-170 (e.g., each wall section 162-170; the intermediate wall sections 164, 166, 168 disposed between the wall section 162 closest to the inlet 120 and the wall section 170 closest to the outlet 130) may have a curved or rounded shape and/or one or more of the joints 172-178 may be disposed at the vertex or nadir of an arc, curved, and/or rounded shape formed by two adjacent wall sections 162-170.

A first angle α₁ of the first joint 172 is defined by and between the first and second wall sections 162, 164. A second angle α₂ of the second joint 174 is defined by and between the second and third wall sections 164, 166. A third angle α₃ of the third joint 176 is defined by and between the third and fourth wall sections 166, 168. A fourth angle α₄ of the fourth joint 178 is defined by and between the fourth and fifth wall sections 168, 170. Each of the aforementioned angles may be determined, set, and/or dictated by one or more factors, such as the width of the duct 100 (i.e., the distance between the collection plates 210, 210′ when the face plate assemblies 200, 200′ are in their closed positions), the respective distance between the joint 172-178 and the closest collection plate 210, 210', and/or the respective distance from the joint 172-178 to each immediately adjacent joint 172-178 (e.g., the distance from the second joint 174 to the first joint 172 and the distance from the second joint 174 to the third joint 176). The aforementioned angles may be set and/or minimized to provide and/or achieve a desired balance between wear, flow, and performance. Although the respective angles are shown to form a sharp, straight edge, it will be appreciated that the angles may instead represent a radius upon which the respective wall sections 162-170 are curved or rounded relative to one another.

The arrangement of the joints 172-178 and/or the distance between at least some pairs of adjacent joints 172-178 maximizes the effect of the wave deflector 160 in locations of maximum magnetism within the duct 100 and/or passage 140. For example, at least some pairs of adjacent joints 172-178 (e.g., the second joint 174 and the third joint 176) are disposed spaced apart from one another in the flow direction of the airflow 20 at a distance that is equal to the distance between the poles of the plurality of magnets 308, 308′ of the first and/or second magnet assembly 300, 300′. In a direction perpendicular to the direction of the airflow 20, the centerline 142 of the passage 140, and/or the first and second walls 104, 106 of the duct 100, at least some of the joints 172-178 are disposed in substantial alignment with and/or just in front/upstream of (e.g., a short distance, such as a few millimeters) a respective portion or region of one of the magnet assemblies 300, 300′ and/or face plate assemblies 200, 200′ where the magnetic force of the magnetic field(s) is stronger (i.e., a region of higher and/or greater magnetic flux density), which may be considered and/or referred to as a peak gauss region 154A, 154B. For example, in the illustrative example of FIG. 3B, the second joint 174 and/or the first high-speed region 148A is disposed in substantial alignment with and/or just in front/upstream of a first peak gauss region 154A of the first magnet assembly 300 and/or the first face plate assembly 200, and the third joint 176 and/or the second-high speed region 148B is disposed in substantial alignment with and/or just in front/upstream of the second peak gauss region 154B of the second magnet assembly 300′ and/or the second face plate assembly 200′.

The distance between one or more of the joints 172-178 and the nearest collection plate 210, 210′ (e.g., the distance between the second joint 174 and the collection plate 210 of the first face plate assembly 200; the distance between the third joint 176 and the collection plate 210′ of the second face plate assembly 200′) when the face plate assemblies 200, 200′ are in the closed position varies based on one or more desired performance parameters of the magnetic separator 12 (e.g., the desired back pressure, the desired change in flow speed between a narrow, high-speed region 148A, 148B of the passage 140 and an adjacent wide, low-speed region 150A, 150B, and/or the desired minimum magnetic force present in a narrow, high-speed region 148A, 148B). For example, the distance between a joint 172-178 and the nearest collection plate 210, 210′ may be larger when a lower back pressure, a smaller change in flow speed, and/or a lower minimum magnetic force is desired. The distance between a joint 172-178 and the nearest collection plate 210, 210′ may be smaller when a higher back pressure, a larger change in flow speed, and/or a higher minimum magnetic force is desired.

The wave deflector 160 is structured and arranged in the passage 140 to create several chokepoints and/or narrow regions 148A, 148B in the passage 140 and several opposing wide-points and/or wide regions 150A, 150B in the passage 140. The airflow 20 and dilute phase powder material 30 flows through the narrow regions 148A, 148B of the passage 140 at a first and/or higher speed. The airflow 20 and dilute phase powder material 30 flows through the wide regions 150A, 150B of the passage 140 at a second and/or lower speed. By slowing down the speed of the airflow 20 and the dilute phase powder material 30, the wide, low-speed regions 150A, 150B of the passage 140 increase the amount of time that the airflow 20 and the dilute phase powder material 30 are disposed in the magnetic field(s) of the magnetic separator 12. This enables the magnetic separator 12 to remove more ferrous material 34 and/or a greater variety of ferrous material 34 particles from the dilute phase powder material 30, including particles of ferrous material 34 that only need to spend a short amount of time within the magnetic field(s) to be removed and particles of ferrous material 34 that may need to spend a longer duration of time within the magnetic field(s) to be removed. Additionally, in the narrow, high-speed regions 148A, 148B of the passage 140, the wave deflector 160 guides, directs, and/or forces the dilute phase powder material 30 closer to a portion or region of one of the face plate assemblies 200, 200′ where the magnetic force of the magnetic field(s) is stronger (i.e., a region of higher and/or greater magnetic flux density, such as peak gauss regions 154A, 154B). This enables the magnetic separator 12 to remove more ferrous material 34 and/or a greater variety of ferrous material 34 particles from the dilute phase powder material 30, including an increased number of particles of ferrous material 34 that may require a stronger magnetic force to be removed. Optionally, the wave deflector 160 creates several regions in the passage 140 (e.g., the inlet region 144, the outlet region 152, and the base-speed regions 146A-146D) through which the airflow 20 and the dilute phase powder material 30 pass and/or flow at a base, initial, and/or third speed, which is slower than first speed, faster than the second speed, and (optionally) substantially equal to the speed at which the airflow 20 was initially conveyed to the magnetic separator 12, the duct 100, and/or the inlet 120. Optionally, in some examples like the one illustrated in FIG. 4, a first series of alternatingly arranged narrow, high-speed regions and wide, low-speed regions (e.g., regions 148A′, 150B′, 148C′, 150D′) is formed on and/or along a first side of the wave deflector 160', and a second series of alternatingly arranged narrow, high-speed regions and wide, low-speed regions (e.g., regions 150A′, 148B′, 150C′, 148D′) is formed on and/or along an opposite second side of the wave deflector 160′.

An inlet region 144 of the passage 140 is disposed upstream of the wave diverter 160 and is at least partially formed and/or defined by the inlet 120 and/or the duct 100 (e.g., duct frame 102 and/or walls 104-110). A first base-speed region 146A is formed and/or defined by and between the first wall section 162 and the first face plate assembly 200. Opposite the first base-speed region 146A, a second base-speed region 146B is formed and/or defined by and between the first wall section 162 and the second face plate assembly 200′. A first narrow, high-speed region 148A of the passage 140 is formed and/or defined between the first face plate assembly 200 and a portion of the wave deflector 160 containing the second joint 174 (e.g., the portion of the second wall section 164 and the portion of the third wall section 166 that are offset from the centerline 142 of the passage 140 toward the first face plate assembly 200). Opposite the first high-speed region 148A, a first wide, low-speed region 150A of the passage 140 is formed and/or defined between the second face plate assembly 200′ and the portion of the wave deflector 160 containing the second joint 174 (e.g., the portion of the second wall section 164 and the portion of the third wall section 166 that are offset from the centerline 142 of the passage 140 toward the first face plate assembly 200). A second narrow, high-speed region 148B of the passage 140 is formed and/or defined between the second face plate assembly 200′ and a portion of the wave deflector 160 containing the third joint 176 (e.g., the portion of the third wall section 166 and the portion of the fourth wall section 168 that are offset from the centerline 142 of the passage 140 toward the second face plate assembly 200′). Opposite the second high-speed region 148B, a second wide, low-speed region 150B of the passage 140 is formed and/or defined between the first face plate assembly 200 and the portion of the wave deflector 160 containing the third joint 176 (e.g., the portion of the third wall section 166 and the portion of the fourth wall section 168 that are offset from the centerline 142 of the passage 140 toward the second face plate assembly 200′). A third base-speed region 146C is formed and/or defined by and between the fifth wall section 170 and the first face plate assembly 200. Opposite the third base-speed region 146C, a fourth base-speed region 146D is formed and/or defined by and between the fifth wall section 170 and the second face plate assembly 200′. An outlet region 152 of the passage 140 is disposed downstream of the wave diverter 160 and is at least partially formed and/or defined by the outlet 130 and/or the duct 100 (e.g., duct frame 102 and/or walls 104-110).

The flow and/or movement of the airflow 20 and dilute phase powder material 30 through the passage 140 of the magnetic separator 12 depicted in FIGS. 1-3B, including in the inlet region 144, the first narrow/high-speed region 148A, the first wide/low-speed region 150A, the second narrow/high-speed region 148B, the second wide/low-speed region 150B, and the outlet region 152, would look substantial similar to that shown in FIG. 4, which depicts an image from an air speed and flow simulation conducted with a magnetic separator 100′ having a wave deflector 160′ with seven walls sections. Due to the additional wall sections of the wave deflector 160′ in FIG. 4, the passage 140′ includes an inlet region 144′, an outlet region 152′, a first, second, third, and fourth base-speed region 146A′ 146B′, 146C′, 146D′, a first, second, third, and fourth narrow/high-speed region 148A′ 148B′, 148C′, 148D′, and a first, second, third, and fourth wide/low-speed region 150A′ 150B′, 150C′, 150D′.

As generally illustrated in FIGS. 1 and 3A, the first face plate assembly 200 is disposed on the first side of the duct 100 and selectively closes the first opening 112 of the first wall 104 of the duct 100. The first face plate assembly 200 includes a collection plate 210 and a seal 230. The collection plate 210 is a generally planar, rectangular body. Optionally, the collection plate 210 includes and/or defines a depression and/or receptacle 216 that receives at least a portion of the first magnet assembly 300 (e.g., at least a portion of the magnet cassette 306). The depression 216 is disposed in and/or projects into an outer surface 212 of the collection plate 210 facing away from the duct 100. The collection plate 210 further includes and/or defines a groove 218 that receives at least a portion of the seal 230. The groove 218 is disposed in and/or projects into a collection surface 214 of the collection plate 210 facing toward the duct 100. The seal 230 is disposed in the groove 218 and sealingly contacts and/or abuts the first wall 104 of the duct 100 when the first face plate assembly 200 is in the closed position providing a fluid tight seal 230 around the first opening 112. Alternatively, the duct 100 and/or the first wall 104 includes the groove 218 and the seal 230 rather than the first face plate assembly 200 (i.e., the groove 218 is disposed in and/or define by the first wall 104 and extends around the first opening 112, and the seal 230 is disposed in the groove 218 and sealingly contacts the collection plate 210 when the first face plate assembly 200 is in the closed position). Three steps and/or protrusions 220 are disposed on the collection surface 214 of the collection plate 210 and project into the passage 140 when the first face plate assembly 200 is in the closed position. The protrusions 220 restrict and/or prevent dislodgement and/or movement (e.g., along the collection surface 214) of the collected ferrous material 36, such as due to the airflow 20.

When in the closed position (see, e.g., FIGS. 3A, 3B), the first face plate assembly 200 (e.g., the collection plate 210) is adjustably disposed on the first wall 104 of the duct 100 and the collection plate 210 (e.g., the collection surface 214) at least partially defines the passage 140. The first face plate assembly 200 sealingly contacts and/or abuts the first wall 104 (e.g., via the seal 230) closing the first opening 112 in a fluid tight manner.

When in the cleaning position (see, e.g., FIG. 1), the first face plate assembly 200 (e.g., the collection plate 210) is disposed spaced apart from the first wall 104 of the duct 100 and does not close the first opening 112 such that the passage 140 is in fluid communication with the external environment via the first opening 112. The first face plate assembly 200 (e.g., the collection plate 210 and/or the collection surface 214 thereof) is disposed a sufficient distance from the passage 140 and/or the first opening 112 such that the collected ferrous material 34 accumulated on the collection plate 210 will not re-enter the duct 100, the passage 140, and/or the airflow 20 when the collected ferrous material 36 is released, cleared, and/or removed from the first face plate assembly 200. The collection surface 214 of the collection plate 210 is oriented such that the collected ferrous material 36 falls off of the collection plate 210 due to gravity when the collected ferrous material 36 are released, cleared, and/or removed from the first face plate assembly 200 (e.g., via the first magnet assembly 300 moving and/or adjusting from the engaged position to unengaged position). Optionally, the first face plate assembly 200 (e.g., the collection plate 210 and/or the collection surface 214 thereof) is disposed above a ferrous material collector, such as a container, conveyor (e.g., conveyor belt, chute, etc.) or the like, relative to the direction of gravity such that the collected ferrous material 36 released, cleared, and/or removed from the first face plate assembly 200 is received and/or collected by the ferrous material collector (e.g., due to gravity).

The first face plate assembly 200 is also adjustable to one or more open positions between the closed position and the cleaning position. When in an open position, the first face plate assembly 200 (e.g., the collection plate 210) is disposed spaced apart from the first wall 104 of the duct 100 and does not close the first opening 112 such that the passage 140 is in fluid communication with the external environment via the first opening 112. However, the first face plate assembly 200 (e.g., the collection plate 210 and/or the collection surface 214 thereof) may not be disposed above the ferrous material collector and/or may not be disposed a sufficient distance from the passage 140 to prevent re-entry of the collected ferrous material 36 into the duct 100, the passage 140, and/or the airflow 20 if the collected ferrous material 36 were to be released, cleared, and/or removed from the first face plate assembly 200.

The first magnet assembly 300 is disposed on the first side of the duct 100 and selectively engages the first face plate assembly 200. The first magnet assembly 300 includes a support plate 302 and a magnet cassette 306. The support plate 302 is a generally planar (e.g., rectangular-shaped or elongated hexagonal-shaped) body. The magnet cassette 306 includes one or more permanent magnets 308. The magnet cassette 306 and/or the magnets 308 are disposed on a magnet surface 304 of the support plate 302 facing toward the duct 100 and/or the first face plate assembly 200. The magnets 308 of the magnet cassette 306 provide and/or generate one or more magnetic fields that attract and/or draw ferrous materials (e.g., ferrous material 34 of the powder material 30).

When in the engaged position (see, e.g., FIGS. 3A, 3B), the first magnet assembly 300 is arranged on the first face plate assembly 200, and/or the magnet cassette 306 and/or the magnets 308 are disposed at least partially in the depression 216 of the collection plate 210. The first magnet assembly 300 is disposed in the engaged position when the first face plate assembly 200 is in the closed position. As such, the magnetic field(s) of the first magnet assembly 300 extend and/or project into the passage 140 (e.g., through the first face plate assembly 200 and/or the collection plate 210) and interact with the dilute phase powder material 30 flowing therethrough. The ferrous material 34 in the dilute phase powder material 30 is drawn to and retained on (e.g., held against) the collection surface 214 of the collection plate 210 of the first face plate assembly 200 via the magnet field(s) of the first magnet assembly 300. In this way, the ferrous material 34 is separated and/or removed from the dilute phase powder material 30 and/or the airflow 20.

The first magnet assembly 300 generally moves in conjunction with the first face plate assembly 200 at least when the first face plate assembly 200 is moved and/or adjusted from the closed position to the cleaning position such that the first magnet assembly 300 remains in the engaged position while the first face plate assembly 200 is moved and/or adjusted from the closed position to the cleaning position. As such, the first magnet assembly 300 retains and/or holds the collected ferrous material 36 on the collection plate 210 and effectively prevents the collected ferrous material 36 from re-entering the duct 100, passage 140, and/or airflow 20 while moving and/or adjusting the first face plate assembly 200 from the closed position to the cleaning position.

When in the unengaged position (see, e.g., FIG. 1), the first magnet assembly 300 is disposed spaced apart from (i.e., is not arranged on and/or engaged with) the first face plate assembly 200, and/or the magnet cassette 306 and/or the magnets 308 are disposed outside of (i.e., are not disposed and/or received in) the depression 216 of the collection plate 210. The magnet cassette 306 and/or the magnets 308 are disposed a sufficient distance from the first face plate assembly 200 and/or the collection plate 210 thereof that the magnetic field(s) of the first magnet assembly 300 are unable retain and/or hold at least some of the collected ferrous material 36 on the collection plate 210 and/or the first face plate assembly 200 (i.e., the magnetic forces provided by the first magnet assembly 300 are not sufficiently strong to hold and/or maintain at least some of the collected ferrous material 36 on the collection plate 210) and the collected ferrous material 36 is thereby released therefrom. Once released, the collected ferrous material 36 is able to naturally fall off of the collection plate 210 due to gravity. Alternatively, the magnet cassette 306 and/or the magnets 308 may be disposed a slightly shorter distance from the first face plate assembly 200 and/or the collection plate 210 thereof so that the magnetic field(s) of the first magnet assembly 300 are weaker and only loosely retain and/or hold the collected ferrous material 36 on the collection plate 210 and/or the first face plate assembly 200, thereby allowing the collected ferrous material 36 to be more easily removed from the collection plate 210, such as with the application of less and/or a relatively minor amount of force (e.g., via wiping, scraping, a stream and/or flow of fluid, etc.).

Generally, the first magnet assembly 300 is moved and/or adjusted from the engaged position to the unengaged position only when the first face plate assembly 200 is disposed in the cleaning position. This ensures that the collected ferrous material 36 is not released from the collection plate 210 and/or the first face plate assembly 200 prematurely where it could potentially re-enter the duct 100, the passage 140, and/or the airflow 20. However, in other examples, the first magnet assembly 300 may begin moving from the engaged position to the unengaged position (i.e., away from the first face plate assembly 200) when the first face plate assembly 200 is not in the cleaning position, such as while the first face plate assembly 200 is in the process of moving to the cleaning position. In such examples, the first magnet assembly 300 may start moving toward the unengaged position once the collected ferrous material 36 retained on the first face plate assembly 200 is unlikely to re-enter the duct 100 if it were released, such as when the first face plate assembly 200 has moved a predetermined distance from the duct 100 and/or the first opening 112 (e.g., when the first face plate assembly 200 is close to and/or nearly reached the cleaning position) and/or at a point in time that allows for the first face plate assembly 200 to reach the cleaning position prior to the first magnet assembly 300 moving far enough from the first face plate assembly 200 that the magnetic field(s) of the first magnet assembly 300 are unable to retain and/or hold the collected ferrous material 36 on the collection plate 210.

The second face plate assembly 200′ is disposed on the second side of the duct 100 and selectively closes the second opening 114 of the second wall 106 of the duct 100. The second face plate assembly 200′ is configured as a mirror image of the first face plate assembly 200 and functions in a substantially similar and/or the same manner as the first face plate assembly 200. The second face plate assembly 200′ includes a collection plate 210′, outer surface 212′, collection surface 214′, depression 216′, groove 218′, steps 220′, and seal 230′ that are configured and function in a substantially similar and/or the same manner as the corresponding features of the first face plate assembly 200. Alternatively, the duct 100 and/or the second wall 106 of the duct 100 includes the groove 218′ and the seal 230′ rather than the second face plate assembly 200′ (i.e., the groove 218′ is disposed in and/or define by the second wall 106 and extends around the second opening 114, and the seal 230′ is disposed in the groove 218′ and sealingly contacts the collection plate 210′ when the second face plate assembly 200′ is in the closed position). The second face plate assembly 200′ is adjustable to a closed position, one or more open positions, and a cleaning position in a substantially similar and/or the same manner as the first face plate assembly 200. When the second face plate assembly 200′ is in the closed position, an open position, and the cleaning position, the collection plate 210′, depression 216′, groove 218′, steps 220′, and seal 230′ of the second face plate assembly 200′ are disposed relative to one another, to the second magnet assembly 300′, to the duct 100 (e.g., the second wall 106 and/or the second opening 114), and/or to the passage 140 in a substantially similar and/or the same manner as the corresponding features of the first face plate assembly 200 when the first face plate assembly 200 is in the closed position, an open position, and the cleaning position.

The second magnet assembly 300′ is disposed on the second side of the duct 100 and selectively engages the second face plate assembly 200′. The second magnet assembly 300′ is configured as a mirror image of the first magnet assembly 300 and functions in a substantially similar and/or the same manner as the first magnet assembly 300. The second magnet assembly 300′ includes a support plate 302′, a magnet surface 304′, a magnet cassette 306′, and one or a plurality of permanent magnets 308′ that are configured in a substantially similar and/or the same manner as the corresponding features of the first magnet assembly 300. The second magnet assembly 300′ is adjustable to an engaged position and an unengaged position in a substantially similar and/or the same manner as the first magnet assembly 300. When the second magnet assembly 300′ is in the engaged position and the unengaged position, the support plate 302′, the magnet cassette 306′, and permanent magnets 308′ of the second magnet assembly 300′ are disposed relative to one another, to the second face plate assembly 200′, to the duct 100 (e.g., the second wall 106 and/or second opening 114), and/or to the passage 140 in a substantially similar and/or the same manner as the corresponding features of the first magnet assembly 300 when the first magnet assembly 300 is in the engaged position and the unengaged position.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g. ” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A magnetic separator for a pneumatic conveyor system, comprising:
a duct defining a passage through which an airflow and a powder material suspended in the airflow is flowable, the powder material including non-ferrous material and ferrous material;
at least one face plate assembly disposed on a side of the duct;
at least one magnet assembly disposed on the side of the duct, the at least one magnet assembly providing at least one magnetic field that draws the ferrous material toward the at least one face plate assembly and retains the ferrous material on the at least one face plate assembly; and
a wave-shaped deflector arranged in the passage;
wherein the deflector is structured and arranged to direct the airflow and the powder material suspended therein through the passage and, at least in some regions, toward the at least one face plate assembly.

2. The magnetic separator of claim 1, wherein the deflector includes a plurality of wall sections arranged at an angle relative to one another to form a wave shape.

3. The magnetic separator of claim 2, wherein:
the deflector further includes a plurality of joints at which adjacent wall sections of the plurality of wall sections adjoin one another;
a first joint of the plurality of joints is offset toward the at least one face plate assembly forming a chokepoint such that a high-speed region of the passage is formed between the deflector and the at least one face plate assembly; and
the airflow and the powder material suspended therein flow through the high-speed region of the passage at a higher speed than one or more other regions of the passage.

4. The magnetic separator of claim 3, wherein the first joint is disposed in alignment with and/or upstream of a peak gauss region of the at least one magnet assembly.

5. The magnetic separator of claim 3, wherein:
opposite the high-speed region, a low-speed region of the passage is formed at least partially by the deflector; and
the airflow and the powder material suspended therein flow through the low-speed region of the passage at a lower speed than through the high-speed region.

6. The magnetic separator of claim 2, wherein the plurality of wall sections includes:
a first wall section;
a second wall section projecting transversely from the first wall section in a direction toward the at least one face plate assembly; and
a third wall section projecting transversely from the second wall section in a direction away from the at least one face plate assembly.

7. The magnetic separator of claim 1, wherein:
the passage includes a plurality of high-speed regions and a plurality of low-speed regions, the airflow and the powder material suspended therein flowing through the plurality of high-speed regions of the passage at a higher speed than through the plurality of low-speed regions;
a first series of alternatingly arranged high-speed regions and low-speed regions of the passage are defined on a first side of the deflector; and
a second series of alternatingly arranged high-speed regions and low-speed regions of the passage are defined on an opposite, second side of the deflector.

8. The magnetic separator of claim 1, wherein the deflector is a continuous, monolithic wall connected to the duct.

9. The magnetic separator of claim 1, wherein the deflector extends completely across the passage.

10. The magnetic separator of claim 1, wherein the at least one face plate assembly is adjustable and the duct includes at least one opening that is selectively openable and closable via the at least one face plate assembly.

11. The magnetic separator of claim 10, wherein the at least one face plate assembly is adjustable to:
a closed position in which the at least one face plate assembly is arranged on the duct and closes the at least one opening; and
a cleaning position in which the at least one face plate assembly is disposed spaced apart from the duct and does not close the at least one opening, and the ferrous material retained on the at least one face plate assembly is removable from the at least one face plate assembly without re-entering the duct.

12. The magnetic separator of claim 11, further comprising a seal, wherein:
the at least one face plate assembly includes i) a collection plate, ii) a groove disposed in and defined by the collection plate, and iii) a seal disposed in the groove; and
when the at least one face plate assembly is in the closed position, i) the collection plate closes the at least one opening of the duct and at least partially defines the passage and ii) the seal sealingly abuts a wall of the duct in which the at least one opening is disposed and forms a fluid tight seal around the at least one opening.

13. The magnetic separator of claim 1, wherein the at least one magnet assembly is an adjustable magnet assembly that is adjustable to:
an engaged position in which the at least one magnet assembly is arranged on the at least one face plate assembly; and
an unengaged position in which the at least one magnet assembly is disposed spaced apart from the at least one face plate assembly.

14. The magnetic separator of claim 13, wherein, when in the unengaged position, the at least one magnet assembly is disposed a sufficient distance from the at least one face plate assembly that the at least one magnetic field is unable to retain the ferrous material on the at least one face plate assembly and the ferrous material is removable from the at least one face plate assembly via gravity.

14. The magnetic separator of claim 15, wherein:
the at least one face plate assembly includes a collection plate that at least partially defines the passage when the at least one face plate assembly is in a closed position; and
the at least one magnet assembly includes a magnet cassette that is disposed in a depression of the collection plate when the at least one magnet assembly is in the engaged position and that is disposed outside of the depression of the collection plate when the magnet assembly is in the unengaged position.

16. The magnetic separator of claim 1, wherein:
the at least one face plate assembly is an adjustable face plate assembly that includes:
a first face plate assembly configured to selectively open and close a first opening of the duct; and
a second face plate assembly configured to selectively open and close a second opening of the duct; and
the at least one magnet assembly includes:
a first magnet assembly configured to selectively engage the first face plate assembly; and
a second magnet assembly configured to selectively engage the second face plate assembly.

17. A magnetic separator for a pneumatic conveyor system, comprising:
a duct defining a passage through which an airflow and a powder material suspended in the airflow is flowable, the powder material including non-ferrous material and ferrous material;
a plurality of adjustable face plate assemblies including a first face plate assembly disposed on a first side of the duct and a second face plate assembly disposed on a second side of the duct;
a plurality of adjustable magnet assemblies including a first magnet assembly disposed on the first side of the duct and a second magnet assembly disposed on the second side of the duct, the plurality of magnet assemblies providing a plurality of magnetic fields that draw the ferrous material toward the plurality of face plate assemblies and retain the ferrous material on the plurality of face plate assemblies; and
a wave-shaped deflector arranged in the passage;
wherein the deflector is structured and arranged to direct the airflow and the powder material suspended therein through the passage and, at least in some regions, toward at least one of the plurality of face plate assemblies.

18. The magnetic separator of claim 17, wherein the deflector includes a plurality of wall sections arranged at an angle relative to one another to form a wave shape, the plurality of wall sections including:
a first wall section;
a second wall section projecting transversely from the first wall section in a direction toward the first face plate assembly;
a third wall section projecting transversely from the second wall section in a direction toward the second face plate assembly;
a fourth wall section projecting transversely from the third wall section in a direction toward the first face plate assembly; and
a fifth wall section projecting transversely from the fourth wall section.

19. The magnetic separator of claim 18, wherein the first wall section and the fifth wall section extend substantially parallel to a longitudinal direction of the passage.

20. The magnetic separator of claim 17, wherein:
the duct includes:
a first opening selectively openable and closable via the first face plate assembly; and
a second opening disposed opposite the first opening and selectively openable and closable via the second face plate assembly;
the first face plate assembly and the second face plate assembly are each adjustable to:
a closed position in which the respective face plate assembly is arranged on the duct and closes the associated opening; and
a cleaning position in which the respective face plate assembly is disposed spaced apart from the duct and does not close the associated opening, and the ferrous material retained on the respective face plate assembly is removable therefrom without re-entering the duct;
the first magnet assembly is configured to selectively engage the first face plate assembly and the second magnet assembly is configured to selectively engage the second face plate assembly; and
the first magnet assembly and the second magnet assembly are each adjustable to:
an engaged position in which the respective magnet assembly is arranged on the associated face plate assembly; and
an unengaged position in which the respective magnet assembly is disposed spaced apart from the associated face plate assembly.
